(19) United States
(12) Patent Application Publication
(10) Pub. No.: US 2014/0140835 A1
(43) Pub. Date: May 22, 2014

(54) COMPONENT WITH CLADDING SURFACE AND METHOD OF APPLYING SAME

(71) Applicant: CATERPILLAR INC., Peoria, IL (US)

(72) Inventors: Justin Curtis Embrey, Morton, IL (US); Daniel Herbert Gerke, Chillicothe, IL (US); M. Brad Beardsley, Laura, IL (US); Ondrej Racek, Yverdon les Bains (CH)

(73) Assignee: CATERPILLAR INC., Peoria, IL (US)

(21) Appl. No.: 13/681,954

(22) Filed: Nov. 20, 2012

(51) Int. Cl. B32B 15/04; B23K 26/34; F04D 7/04

(52) U.S. Cl. CPC B32B 15/043; F04D 7/04; B23K 26/345
USPC 415/204; 428/627; 219/121.64

(57) ABSTRACT

A slurry pump component includes a base member with a cladding surface. The cladding surface includes a brazing alloy inner layer, a ductile intermediate layer and a wear resistant outer layer.

### TECHNICAL FIELD

The present disclosure relates generally to a component and, more particularly, to a component having a cladding surface and a method of applying same.

### BACKGROUND

Commercial slurry pumps contain internal components that are subject to abrasive and erosive wear from interactions between slurry solids and surfaces of the pump components. Over time, the surfaces of the pump components can wear out. In some instances, the surfaces of the components develop gouges from abrasive and erosive interactions with the slurry. To extend the useful life of the slurry pump components, some surfaces of the pump components are coated with wear resistant materials.

Typical wear resistant materials are applied through a cladding process. For example, tungsten carbide disposed in a nickel matrix is clad on surfaces of slurry pump components.

Tungsten carbide in a nickel matrix, however, has a high melting point, which can cause cracks in the base material of the pump component because the base material is heated and cooled rapidly during the cladding process. These cracks can propagate in components that are subject to centrifugal stresses during operation (i.e., impellers and volutes) and ultimately result in catastrophic failure of the pump.

The manufacturing process of the present disclosure solves one or more of the problems set forth above and/or other problems in the art.

### SUMMARY

In one aspect, the present disclosure is directed toward a slurry pump component. The slurry pump component may include a base member with a cladding surface. The cladding surface may include a brazing alloy inner layer, a ductile intermediate layer and a wear resistant outer layer.

In another aspect, the present disclosure is related to a method of manufacturing a slurry pump component. The method may include laser cladding a brazing alloy inner layer onto a base member surface of the slurry pump component, then laser cladding a ductile intermediate layer over the brazing alloy inner layer. The method may additionally include laser cladding a wear resistant layer over the ductile intermediate layer.

### BRIEF DESCRIPTION OF THE DRAWINGS

FIG. 1 is an exploded view pictorial illustration of an exemplary disclosed slurry pump;

FIG. 2 is a pictorial illustration of an exemplary disclosed throat bush that may be used in conjunction with the slurry pump of FIG. 1;

FIG. 3 is another pictorial illustration of the throat bush of FIG. 2;

FIG. 4 is a cross-sectional illustration of the throat bush of FIG. 2 and FIG. 3;

FIG. 5 is a pictorial illustration of an exemplary disclosed frame plate liner that may be used in conjunction with the slurry pump of FIG. 1;

FIG. 6 is a pictorial illustration of an exemplary disclosed impeller that may be used in conjunction with the slurry pump of FIG. 1;

FIG. 7 is another pictorial illustration of the impeller of FIG. 6;

FIG. 8 is a pictorial illustration of an exemplary disclosed volute that may be used in conjunction with the slurry pump of FIG. 1;

FIG. 9 is a pictorial illustration of an exemplary disclosed manufacturing process that may be used to apply a surface material to components of the slurry pump of FIG. 1; and

FIG. 10 is a pictorial illustration of an exemplary disclosed multi-layer cladding surface that may be used in conjunction with the impeller of FIG. 6 and FIG. 7 and the volute of FIG. 8.

### DETAILED DESCRIPTION

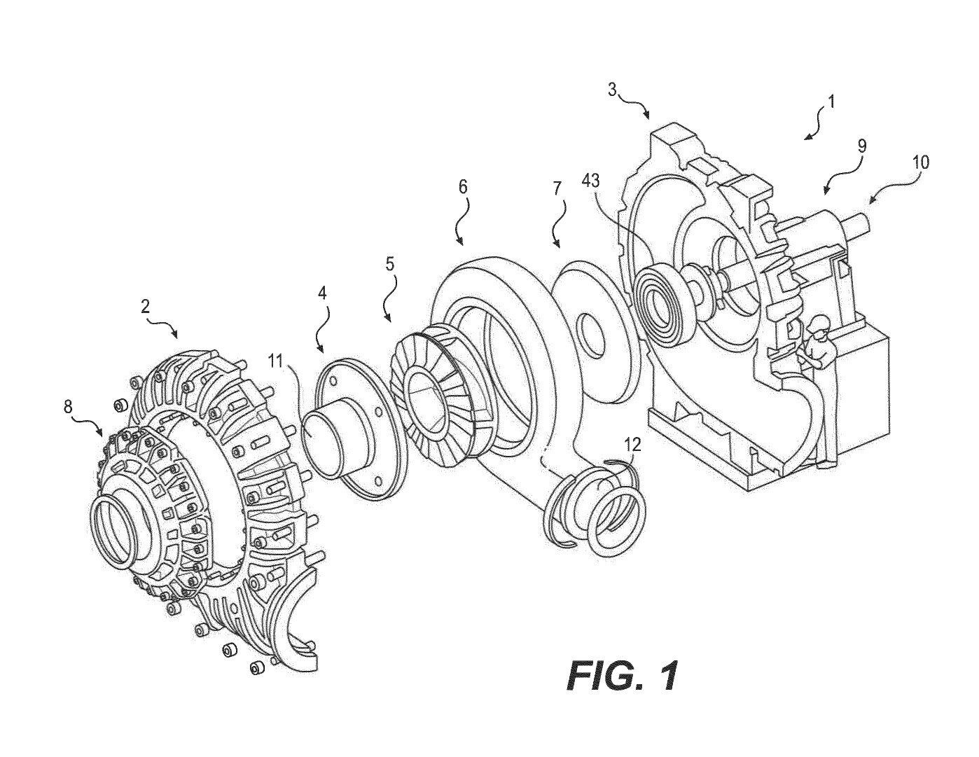

FIG. 1 illustrates an exploded view of a slurry pump 1 according to the present disclosure. Slurry pump 1 may be used to pump slurries, or mixtures of a liquid and solids. For example, slurry pump 1 may be used to transport mixtures of oil and sand. Slurry pump 1 may alternatively be used in other large and small particle size transport processes.

Slurry pump 1 may include a suction plate 8, a cover plate 2, and a frame plate 3, which together may form a slurry pump housing. The slurry pump housing may be formed by mounting suction plate 8 to cover plate 2, and then mounting cover plate 2 to frame plate 3. Inside the slurry pump housing, a throat bush 4 may mount to suction plate 8 at an inlet. Impeller 5 may mount to a shaft 10, which provides the rotational force to move impeller 5. Impeller 5 may reside in a volute 6. As slurry enters throat bush 4 via an opening 11, it may flow into impeller 5 and be pushed by centrifugal force through volute 6 to exit slurry pump 1 through an opening 11 in volute 6. Frame plate liner 7 may be placed between volute 6 and frame plate 3, and a seal 43 may be placed between frame plate liner 7 and frame plate 3 to help keep slurry from leaking out of volute 6. A bearing assembly 9 may help to reduce friction between shaft 10 and the pump housing while impeller 5 is rotating.

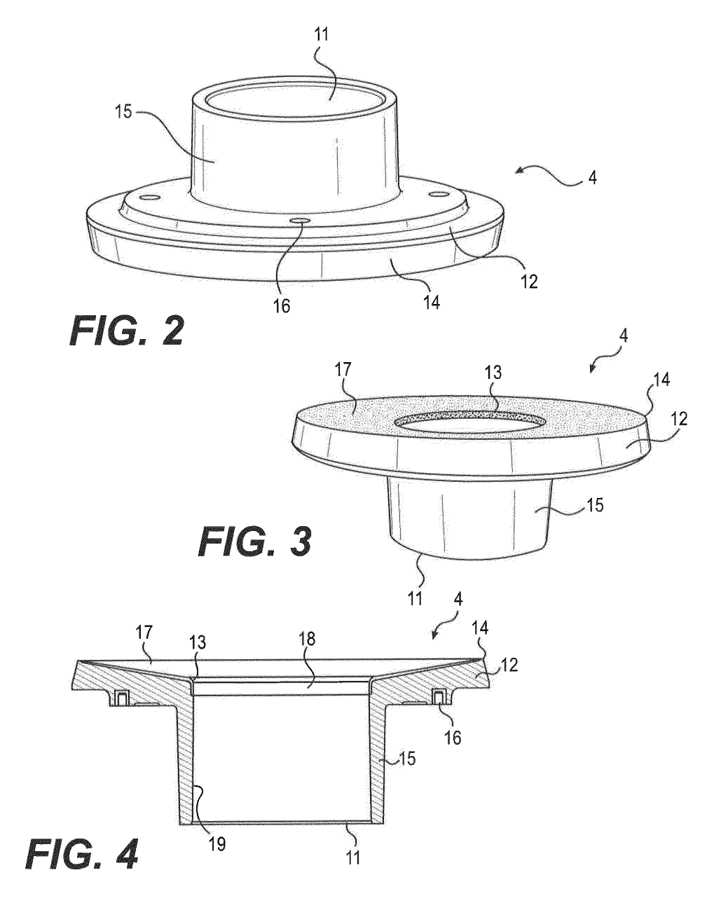

FIGS. 2-4 illustrate an exemplary throat bush 4 that may be used in slurry pump 1. Throat bush 4 may include a ring-like base 12 having an inner annular surface 13 and an outer annular surface 14. Throat bush 4 may also include a cylindrical collar 15 extending away from ring-like base 12. A plurality of radially distributed bores 16 may be formed in ring-like base 12 and used to attach suction plate 8 to throat bush 4 with fasteners (not shown).

Base 12 may include a conical end 17 located axially opposite collar 15. In one embodiment, as shown in FIG. 4, an outer surface conical end 17 may slope axially inward from the outer annular surface 14 to the inner annular surface 13. Collar 15 may be hollow and include an inner annular surface 18, which may extend about 1 to 12 inches from inner annular surface 13 along the length of an inner surface 19 of collar 15. During operation of slurry pump 1, conical end 17 and inner annular surface 18 may be subject to accelerated abrasion and erosion.

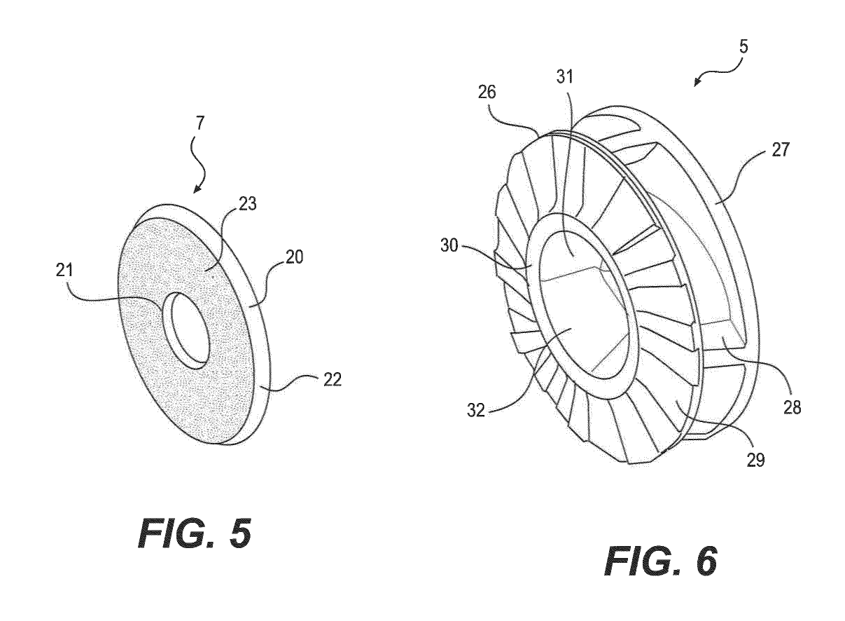

FIG. 5 illustrates an exemplary frame plate liner 7 that may be used in slurry pump 1. In one embodiment, frame plate liner 7 may include a ring-like base member 20 having an inner annular surface 21 and an outer annular surface 22. Base member 20 may also include an axial end 23 that faces volute 6 after assembly. During operation of slurry pump 1, axial end 23 may be subject to accelerated abrasion and erosion.

The slurry pump components may be formed from durable materials. For example, throat bush 4, impeller 5, volute 6, and frame plate liner 7 may be made of an iron or steel. In one embodiment, throat bush 4, impeller 5, volute 6, and frame plate liner 7 may be made of white iron. Conical end 17 and inner annular surface 18 of throat bush 4 and axial end 23 of frame plate liner 7 may be covered with a cladding surface to help reduce wear from abrasive and erosive interactions during operation of slurry pump 1. The cladding surface may include a wear resistant material disposed in a tool steel matrix. In one embodiment, the wear resistant material may have a melting point greater than about 3000° C. and be made from at least one of titanium carbide, zirconium carbide, hafnium carbide, or titanium diboride. In another embodiment, the wear resistant material may be spherical or crushed titanium carbide, and be present in an amount between about 30 and 70 percent by volume, with the remainder being tool steel matrix. The wear resistant material morphology may be agglomerated, agglomerated and sintered, water atomized, gas atomized, or mechanically coated (porously coated).

The tool steel matrix may include iron and one or more of carbon, manganese, chromium, cobalt, vanadium, tungsten, silicon, sulfur, nickel, or molybdenum. For example, the tool steel matrix may include iron and a weight percent composition of about 1.6% carbon, about 0.3% manganese, about 4.0% chromium, about 5.0% cobalt, about 4.9% vanadium, about 12.00% tungsten, about 0.30% silicon, and about 0.06% sulfur.

As shown in FIG. 4, a thickness of the cladding surface at conical end 17 of throat bush 4 may be greater adjacent to inner annular surface 13 than adjacent to outer annular surface 14. In one embodiment, the conical surface end 17 may have a thickness of between about 4 and 12 mm in an area adjacent to inner annular surface 13 and between about 2 and 8 mm in an area adjacent to outer annular surface 14. The thickness of the cladding surface covering inner annular surface 18 of collar 15 may be between about 2 and 8 mm. Referring to FIG. 5, the cladding surface covering axial end 23 of frame plate liner 7 may have a thickness of between about 2 and 12 mm.

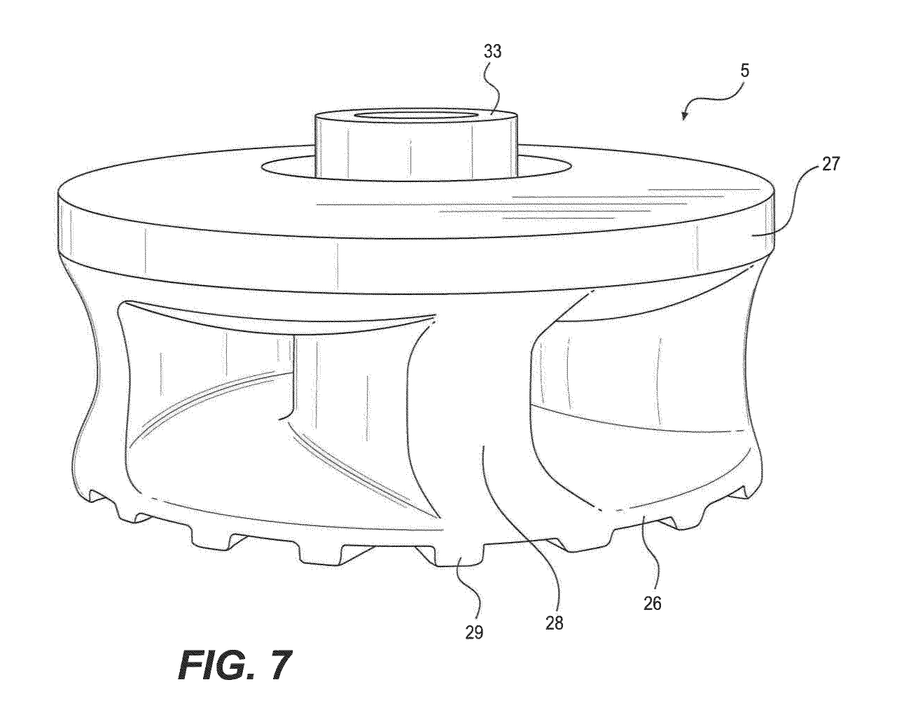

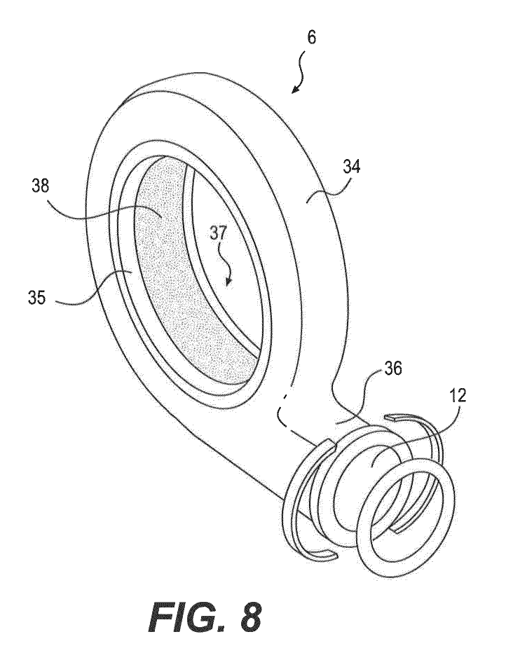

FIGS. 6-7 illustrate an exemplary impeller 5 that may be used in slurry pump 1. In one embodiment, impeller 5 may include a first plate 26 and a second plate 27 spaced apart and generally parallel to first plate 26. Impeller 5 may further include blades 28 that join and support first plate 26 and second plate 27. A plurality of fins 29 may extend from first plate 26 away from second plate 27. In one embodiment, a plurality of fins (not shown) may also extend from second plate 27 away from first plate 26. Impeller 5 may also include a circular opening 30 in a general center of first plate 26, which may be aligned with opening 11 of throat bush 4 (FIG. 2). As slurry passes through throat bush 4, it may first enter impeller 5 through circular opening 30, and pass into an impeller cavity 31. The slurry may then be pushed through a blade opening 32 to the outside of impeller 5 when impeller 5 rotates during operation. A shaft mount 33 may extend from second plate 27 away from first plate 26 and connect to shaft 10 (FIG. 1).

FIG. 8 illustrates an exemplary volute 6 that may be used in slurry pump 1. In one embodiment, volute 6 may include a hollow ring 34 with an open inner radius 35. A hollow cylindrical member 36 may be attached to and extend radially outward from hollow ring 34. The insides of hollow ring 34 and hollow cylindrical member 36 may form an inner cavity 37.

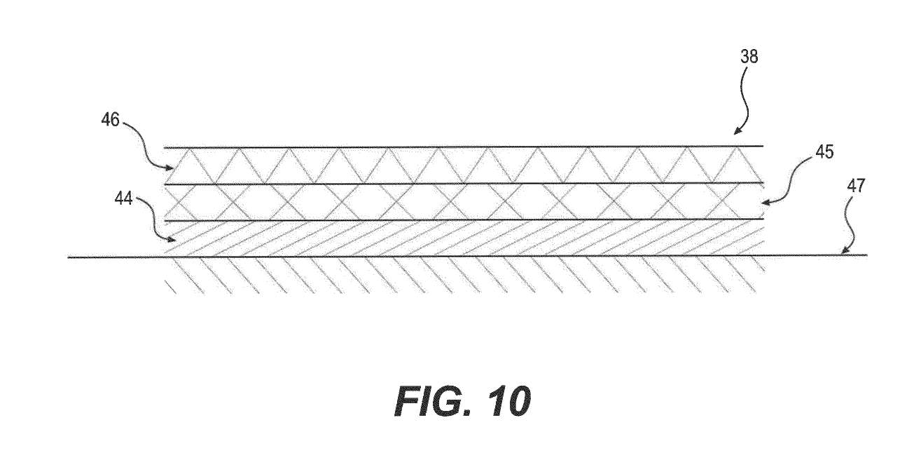

All surfaces of impeller 5 and the surface of inner cavity 37 of volute 6 may be covered with a cladding surface 38 to help reduce wear from abrasive and erosive interactions during operation of slurry pump 1. The cladding surface 38 may be multi-layer to inhibit cracking of the base material and help reduce failure of the slurry pump 1 from centrifugal stress. For example, as shown in FIG. 10, the cladding surface may include a brazing alloy layer 44, a ductile intermediate layer 45, and a wear resistant layer 46. Brazing alloy layer 44 may cover a base member surface 47 and ductile intermediate layer 45 may be situated between brazing alloy layer 44 and wear resistant layer 46. Wear resistant layer 46 may be the outer-most layer of the cladding surface.

In one embodiment, brazing alloy layer 44 may include one or more metals selected from the group consisting of copper, gold, lead, manganese, nickel, phosphorus, silver and tin, and have a melting point of less than 700° C. In another embodiment, ductile intermediate layer 45 may include iron and one or more elements selected from the group consisting of carbon, chromium, copper, magnesium, manganese, nickel, phosphorus and sulfur. In an alternative embodiment, ductile intermediate layer 45 may include a nickel based alloy with a weight composition of about 0 to 30% chromium, 0 to 3% manganese, 0 to 30% molybdenum, 0 to 40% copper, 0 to 40% iron, and a balance of nickel.

Wear resistant layer 46 may include a wear resistant material disposed in a metal matrix. In one embodiment, the wear resistant material may include at least one of tungsten carbide, titanium carbide, zirconium carbide, hafnium. carbide, or titanium diboride. The wear resistant material may be spherical or crushed titanium carbide. In another embodiment, the wear resistant material morphology may be agglomerated, agglomerated and sintered, water atomized, gas atomized, or mechanically coated (porously coated).

In another embodiment, wear resistant layer 46 may include a nickel or tool steel matrix. The tool steel matrix may include iron and one or more of carbon, manganese, chromium, cobalt, vanadium, tungsten, silicon, sulfur, nickel, or molybdenum. In another embodiment, titanium carbide may be present in an amount between about 30 and 70 percent by volume, with the remainder being tool steel matrix. The tool steel matrix may include iron with a weight percent composition of about 1.6% carbon, about 0.3% manganese, about 4.0% chromium, about 5.0% cobalt, about 4.9% vanadium, about 12.00% tungsten, about 0.30% silicon, and about 0.06% sulfur. In another embodiment, the nickel based matrix may include nickel with one or more of chromium, silicon, or boron. Each of brazing alloy layer 44, ductile intermediate layer 45, and wear resistant layer 46 may have a thickness of between about 0.2 mm and 6 mm.

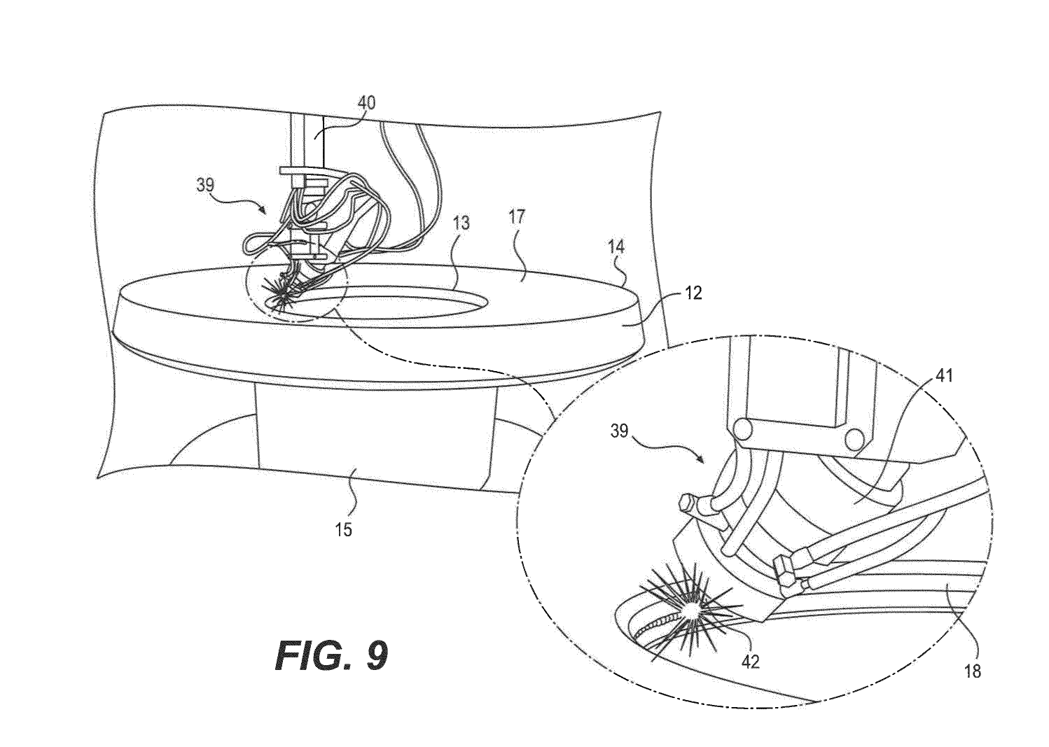

FIG. 9 shows an exemplary laser cladding apparatus 39 including an arm 40 connected to a cladding head 41. Cladding head 41 may be adapted to deliver a laser beam through a chamber defined inside cladding head 41 and is coupled to a laser energy source (not shown). A nozzle 42 delivers cladding powder in a carrier gas, and the laser beam melts the powder to form a surface layer. In one embodiment, cladding apparatus 39 includes a coaxial powder feed along a axis of the laser beam.

### Industrial Applicability

The disclosed components may have use in any slurry pump application or in any other similar application. The configurations of the disclosed components may provide a number of benefits, including haying increased wear resistance and life. A process of manufacturing the wear resistant components will now be described in detail.

The process of manufacturing throat bush 4 and frame plate liner 7 may include laser cladding a base component with a tool steel matrix and at least one of titanium carbide, zirconium carbide, hafnium carbide, or titanium diboride. This process is shown generally in FIG. 9. The process may include laser cladding conical surface end 17 between inner annular surface 13 and outer annular surface 14 of base 12. The process may further include laser cladding inner annular surface 18. In one embodiment, inner annular surface 18 may extend about 1 to 12 inches from inner annular surface 13 of base 12 along the length of inner surface 19 of collar 15.

In one embodiment, the cladding powder may be delivered to nozzle 42 of FIG. 9 at a powder feed rate of up to 6 kg/h, and the laser cladding may be performed at powers up to 1.5 kW and 5.0 kW using a carbon dioxide, Nd:YAG, disc, fiber, or diode laser. The process of manufacturing throat bush 4 may further include laser cladding conical end 17 with a thickness of between 4 and 12 mm adjacent to inner annular surface 13 (FIG. 4) and a thickness of between about 2 and 8 mm adjacent to outer annular surface 14.

The process of manufacturing impeller 5 and volute 6 may include using laser cladding apparatus 39 to form each of (referring to FIG. 10) brazing alloy layer 44, ductile intermediate layer 45, and wear resistant layer 46 by depositing a cladding powder under generally the same process conditions described above. In one embodiment, the thickness of the cladding surface including the brazing alloy layer 44, ductile intermediate layer 45, and wear resistant layer 46 may be between about 6 and 18 mm.

The slurry pump component manufacturing process described above may be performed to increase the wear resistance and life of the components. The slurry pump component manufacturing process may also help inhibit the formation of cracks in the base material because the brazing alloy has a low melting point, which lowers strain caused by heating and cooling of the base material. The presently described manufacturing process may be performed to protect slurry pump components from abrasive and erosive interactions during operation and reduce the risk of catastrophic failure of the slurry pump.

It will be apparent to those skilled in the art that various modifications and variations can be made to the disclosed pump components without departing from the scope of the disclosure. Other embodiments of the components will be apparent to those skilled in the art from consideration of the specification and practice of the pump components herein. It is intended that the specification and examples be considered as exemplary only, with a true scope of the disclosure being indicated by the following claims and their equivalents.

What is claimed is:

1. A slurry pump component, comprising:
a base member; and
a cladding surface on the base member,
wherein the cladding surface includes:
a brazing alloy inner layer;
a ductile intermediate layer; and
a wear resistant outer layer.

2. The component of claim 1, wherein the wear resistant outer layer includes at least one wear resistant material of tungsten carbide, titanium carbide, zirconium carbide, hafnium carbide, or titanium diboride and a metal matrix.

3. The component of claim 1, wherein the brazing alloy inner layer includes one or more metals selected from the group consisting of copper, gold, lead, manganese, nickel, phosphorus, silver and tin.

4. The component of claim 3, wherein the brazing alloy inner layer includes silver.

5. The component of claim 1, wherein the ductile intermediate layer includes iron and one or more elements selected from the group consisting of carbon, chromium, copper, magnesium, manganese, nickel, phosphorus and sulfur.

6. The component of claim 1, wherein the ductile intermediate layer consists of a nickel based alloy with a weight percent composition of about 0 to 30% chromium, 0 to 3% manganese, 0 to 30% molybdenum, 0 to 40% copper, 0 to 40% iron, and a balance of nickel.

7. The component of claim 2, wherein the metal matrix includes nickel or tool steel.

8. The component of claim 1, wherein:
the component is an impeller of a slurry pump;
the base member includes:
a first plate;
a second plate spaced apart and generally parallel to the first plate;
blades that join and support the first and second plates; and
a plurality of fins that extend from the first plate away from the second plate; and
the cladding surface covers at least one of the first plate, the second plate, the blades, or the plurality of fins.

9. The component of claim 1, wherein:
the component is a volute of a slurry pump;
the base member includes:
a hollow ring with an open inner radius; and
a hollow cylindrical member attached to and extending from the hollow ring; and
wherein the insides of the hollow ring and the hollow cylindrical member form an inner cavity; and the cladding surface covers the surfaces of the inner cavity.

10. The component of claim 1, wherein a thickness of the cladding surface is between about 6 and 18 mm.

11. A method of manufacturing a slurry pump component, comprising:
laser cladding a brazing alloy inner layer onto a base member surface of the slurry pump component;
laser cladding a ductile intermediate layer over the brazing alloy inner layer; and
laser cladding a wear resistant outer layer over the ductile intermediate layer.

12. The method of claim 11, wherein laser cladding of the wear resistant outer layer includes depositing a cladding powder including at least one of tungsten carbide, titanium carbide, zirconium carbide, hafnium carbide, or titanium diboride.

13. The method of claim 11, wherein laser cladding of the brazing alloy inner layer includes depositing a cladding powder including one or more metals selected from the group consisting of copper, gold, lead, manganese, nickel, phosphorus, silver and tin.

14. The method of claim 13, wherein laser cladding of the brazing alloy inner layer includes depositing a cladding powder including silver.

15. The method of claim 11, wherein laser cladding of the ductile intermediate layer includes depositing a cladding powder including iron and one or more elements selected from the group consisting of carbon, chromium, copper, magnesium, manganese, nickel, phosphorus and sulfur.

16. The method of claim 11, wherein laser cladding of the ductile intermediate layer includes depositing a cladding powder with a weight percent composition of about 0 to 30% chromium, 0 to 3% manganese, 0 to 30% molybdenum, 0 to 40% copper, 0 to 40% iron, and a balance of nickel.

17. The method of claim 12, wherein laser cladding of the wear resistant outer layer includes depositing a cladding powder of a nickel or tool steel matrix.

18. The method of claim 11, wherein:
the slurry pump component is an impeller of a slurry pump; and
the base member includes:
a first plate;
a second plate spaced apart and generally parallel to the first plate;
blades that join and support the first and second plates; and
a plurality of fins that extend from the first plate away from the second plate; and
laser cladding of the brazing alloy includes laser cladding at least one of the first plate, the second plate, the blades, or the plurality of fins of the impeller.

19. The method of claim 11, wherein:
the base member includes:
a hollow ring with an open inner radius; and
a hollow cylindrical member attached to and extending from the hollow ring, wherein the insides of the hollow ring and the hollow cylindrical member form an inner cavity; and
laser cladding of the brazing alloy inner layer, includes laser cladding the surfaces of the inner cavity.

20. A slurry pump, comprising:
a pump housing;
a throat hush including a slurry inlet inside the pump housing;
a volute located inside the pump housing;
an impeller located in a cavity of the volute;
a frame plate liner located between the volute and the pump housing; and
at least one cladding surface on at least one of the throat bush, volute, impeller, or frame plate liner,
wherein the cladding surface includes:
a brazing alloy inner layer including one or more metals selected from the group consisting of copper, gold, lead, manganese, nickel, phosphorus, silver and tin;
a ductile intermediate layer including iron and one or more elements selected from the group consisting of carbon, chromium, copper, magnesium, manganese, nickel, phosphorus and sulfur; and
a wear resistant outer layer including a metal matrix and at least one wear resistant material of tungsten carbide, titanium carbide, zirconium carbide, hafnium carbide, or titanium diboride.

21. A component, comprising:
a base member; and
a cladding surface on the base member,
wherein the cladding surface includes:
a brazing alloy inner layer;
a ductile intermediate layer; and
a wear resistant outer layer.

22. The component of claim 21, wherein the component is a slurry pump component.
